(19) United States
(12) Patent Application Publication
(10) Pub. No.: US 2025/0102685 A1
(43) Pub. Date: Mar. 27, 2025

(54) RADIATION IMAGING APPARATUS, RADIATION IMAGING SYSTEM, AND METHOD OF CONTROLLING RADIATION IMAGING APPARATUS

(71) Applicant: CANON KABUSHIKI KAISHA, Tokyo (JP)

(72) Inventors: YOSHIAKI SERIZAWA, Kanagawa (JP); TOMOYUKI YAGI, Tokyo (JP); RYOSUKE MIURA, Chiba (JP)

(21) Appl. No.: 18/896,194

(22) Filed: Sep. 25, 2024

(30) Foreign Application Priority Data
Sep. 26, 2023 (JP) 2023-162861

(51) Int. Cl. G01T 1/17

(52) U.S. Cl. CPC G01T 1/17

(57) ABSTRACT

A radiation imaging apparatus comprising: a radiation detecting panel including a plurality of pixels including a first kind of pixel and a second kind of pixel; a unit that obtains a cumulative dose information by performing dose detecting operation for reading charge of the second kind of pixel a plurality of times in a situation where radiation is irradiated and charge is accumulated in the first kind of pixel; a unit that performs processing of stopping the dose detecting operation and stopping the irradiation of radiation based on a combination of a first threshold condition and the cumulative dose information or a combination of a second threshold condition and the cumulative dose information; and a unit that reads the charge of each of the first kind of pixel and the second kind of pixel and obtains a radiation image.

### BACKGROUND OF THE INVENTION

### Field of the Invention

The present disclosure relates to a radiation imaging apparatus, a radiation imaging system, and a method of controlling a radiation imaging apparatus.

### Description of the Related Art

At present, a radiation imaging apparatus comprising a flat panel detector (FPD) including a semiconductor material is widely used for a medical image diagnosis or non-destructive inspection using a radiation such as an X-ray.

Some radiation imaging apparatuses monitor the dose (cumulative dose) of an irradiated radiation, and when the cumulative dose reaches a threshold value, stop the irradiation of radiation by, for example, outputting an irradiation stop signal to a radiation generating apparatus to stop the irradiation of radiation. This operation is referred to as automatic exposure control (AEC), the AEC can suppress, for example, excessive irradiation of the radiation.

As such a radiation imaging apparatus, for example, a radiation imaging apparatus comprising a dose detection unit that detects a radiation dose arriving at an imaging region in the FPD. Japanese Patent Application Laid-Open No. 2023-70098 discloses a technique for stopping the irradiation with high accuracy by transmitting an irradiation stop timing notification before the irradiation stop timing in consideration of delay time for stopping the radiation from the radiation generating apparatus.

Japanese Patent Application Laid-Open No. 2013-135390 discloses a technique for suppressing degradation of image quality by comparing a read-out dose detection signal with a preset threshold, turning off the switching element when the comparison result is obtained to leave dose information in a detection pixel, and performing correction.

However, in the technique disclosed in Japanese Patent Application Laid-Open No. 2023-70098, since no signal remains in a detection pixel, dose information of the detection pixel is defect, and the image quality of the generated radiation image may be degraded. In the technique disclosed in Japanese Patent Application Laid-Open No. 2013-135390, in a case where the irradiation is stopped before the comparison result is obtained, since a signal cannot be left in the detection pixel, dose information of the detection pixel may be defect and the image quality of the generated radiation image may be degraded. Further, in Japanese Patent Application Laid-Open No. 2013-135390, there is no description of the delay time for stopping the irradiation.

In view of such problems, it is an object of an embodiment of the present disclosure to provide a radiation imaging apparatus which can perform irradiation stop control of a radiation from a radiation generating apparatus with high accuracy and can reduce degradation of image quality due to a detection pixel.

### SUMMARY OF THE INVENTION

An radiation imaging apparatus according to an embodiment of the present disclosure comprises: a radiation detecting panel in which a plurality of pixels including a first kind of pixel and a second kind of pixel are arranged in a matrix; a unit configured to obtain a cumulative dose information by performing dose detecting operation for reading charge of the second kind of pixel a plurality of times in a situation where radiation is irradiated and charge is accumulated in the first kind of pixel; a unit configured to perform processing of stopping the dose detecting operation and stopping the irradiation of radiation based on a combination of a first threshold condition and the cumulative dose information or a combination of a second threshold condition and the cumulative dose information; and a unit configured to read the charge of each of the first kind of pixel and the second kind of pixel and obtain a radiation image.

Further features of the present invention will become apparent from the following description of exemplary embodiments with reference to the attached drawings.

### BRIEF DESCRIPTION OF THE DRAWINGS

FIG. 1A is a diagram for illustrating an example of a schematic configuration of a radiation imaging apparatus according to a first embodiment.

FIG. 1B is a diagram for illustrating an example of a circuit configuration of an amplifier according to the first embodiment.

FIG. 2 is a diagram for illustrating an example of a schematic configuration of a radiation imaging system according to the first embodiment.

FIG. 3A is a flowchart showing an example of a series of control method for subject imaging according to the first embodiment.

FIG. 3B is a flowchart showing another example of the series of control method for the subject imaging according to the first embodiment.

FIG. 4 is a diagram for illustrating an example of the relationship between the time variation of a threshold set by a threshold change controlling unit and the dose according to the first embodiment.

FIG. 5 is a diagram for illustrating the operation of the radiation imaging apparatus according to the first embodiment.

FIG. 6 is a flowchart showing an example of a series of control method for subject imaging according to a second embodiment.

### DESCRIPTION OF THE EMBODIMENTS

Preferred embodiments of the present invention will now be described in detail in accordance with the accompanying drawings. However, the dimensions, materials, shapes, and relative positions of the component, and the like described in the following embodiments can be freely set and may be modified depending on the configuration of the apparatus to which the present disclosure applies or various conditions. In the drawings, the same reference numerals are used between the drawings to indicate elements that are identical or functionally similar.

In the following embodiment, a radiation imaging system using X-rays as an example of radiation will be described, but the radiation imaging system according to the present disclosure may use other radiation. Here, the term radiation may include, for example, electromagnetic radiation such as X-rays and y-rays, and particle radiation such as a-rays, B-rays, particle rays, proton rays, heavy ion rays, and meson rays.

### First Embodiment

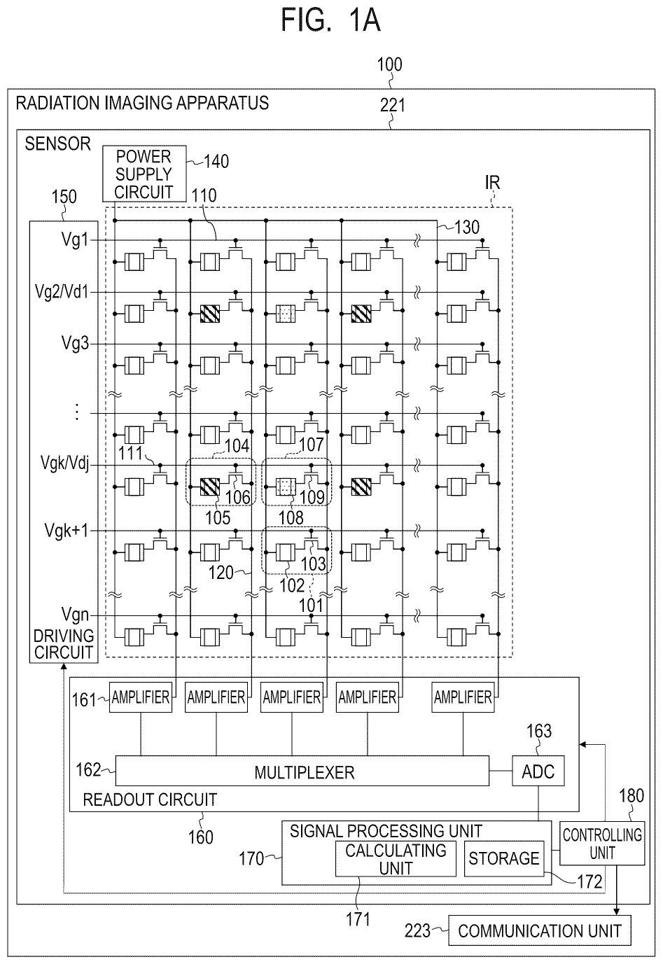

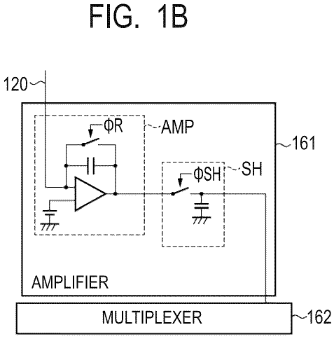

A radiation imaging apparatus, a radiation imaging system, and a method of controlling the radiation imaging apparatus according to a first embodiment of the present disclosure will be described below with reference to FIG. 1A to FIG. 5. FIG. 1A is a diagram for illustrating an example of a schematic configuration of a radiation imaging apparatus 100 according to the first embodiment. The radiation imaging apparatus 100 includes a sensor 221 having a sensor function and a communication unit 223 for communicating with the outside. The sensor 221 includes a power supply circuit 140 for supplying a voltage, a driving circuit 150 for driving a pixel, a readout circuit 160 for reading a signal from the pixel, a signal processing unit 170 for processing the read signal, and a controlling unit 180 for controlling each component.

Further, the sensor 221 includes a plurality of pixels arranged in the imaging region IR so as to constitute a plurality of rows and a plurality of columns, a plurality of driving lines 110, and a plurality of signal lines 120. The plurality of driving lines 110 are arranged corresponding to a plurality of rows of the pixels, and each driving line 110 corresponds to any one pixel row. The plurality of signal lines 120 are arranged corresponding to a plurality of columns of the pixels, and each signal line 120 corresponds to any one pixel column.

The plurality of pixels include a plurality of imaging pixels 101 used for obtaining a radiation image, one or more detection pixels 104 used for monitoring the irradiation amount of the radiation, and one or more correction pixel 107 used for correcting the irradiation amount of the radiation. The sensitivity of the correction pixel 107 to the radiation is lower than the sensitivity of the detection pixel 104 to the radiation. The correction pixel 107 is used for correcting, for example, a temperature fluctuation component or an offset component for the irradiated dose of the radiation.

The imaging pixel 101 includes a conversion element 102 for converting the radiation into an electric signal, and a switch element 103 for connecting the corresponding signal line 120 and conversion element 102 to each other. The detection pixel 104 includes a conversion element 105 for converting the radiation into an electric signal, and a switch element 106 for connecting the corresponding signal line 120 and conversion element 105 to each other. The detection pixel 104 is arranged to be included in the row and the column which are comprised of the plurality of imaging pixels 101. The correction pixel 107 includes a conversion element 108 for converting the radiation to an electrical signal and a switching element 109 for connecting the corresponding signal line 120 and conversion element 108 to each other. The correction pixel 107 is arranged to be included in the row and the column which are comprised of the plurality of imaging pixels 101. In FIG. 1A, the imaging pixel 101, detection pixel 104, and correction pixel 107 are distinguished by different hatching for the conversion element 102, the conversion element 105, and the conversion element 108.

The conversion element 102, the conversion element 105, and the conversion element 108 may include a scintillator for converting the radiation to light and a photoelectric conversion element for converting the light to an electrical signal. The scintillator is typically formed in a sheet shape to cover the imaging region IR and is shared by the plurality of pixels. Alternatively, the conversion element 102, the conversion element 105, and the conversion element 108 may include a conversion element for converting the radiation directly to an electrical signal.

The switching element 103, the switching element 106, and the switching element 109 may include, for example, a thin film transistor (TFT) of which the active region includes a semiconductor such as amorphous silicon or polycrystalline silicon.

A first electrode of the conversion element 102 is connected to a first main electrode of the switching element 103, and a second electrode of the conversion element 102 is connected to a bias line 130. One bias line 130 extends to the column direction and is commonly connected to the second electrodes of the plurality of conversion elements 102 arranged in the column direction. The bias line 130 receives a bias voltage VS from the power supply circuit 140. A second main electrode of the switching element 103 of one or more imaging pixels 101 included in one column is connected to one signal line 120. The control electrode of the switching element 103 of one or more imaging pixels 101 included in one row is connected to one driving line 110.

The detection pixel 104 and the correction pixel 107 have the same pixel configuration as the imaging pixels 101, and are connected to the corresponding bias line 130, the corresponding driving line 110, and the corresponding signal line 120. The detection pixel 104 and the correction pixel 107 are exclusively connected to the signal line 120. That is, the correction pixel 107 is not connected to the signal line 120 to which the detection pixel 104 is connected. Further, the detection pixel 104 is not connected to the signal line 120 to which the correction pixel 107 is connected. The imaging pixel 101 may be connected to the signal line 120 to which the detection pixel 104 or the correction pixel 107 is connected.

The driving circuit 150 is configured to supply a drive signal to the pixel to be driven through the plurality of driving lines 110 in accordance with a control signal from the controlling unit 180. In the first embodiment, the drive signal is a signal for turning on the switch element included in the pixel to be driven. The switch element of each pixel is turned on by a high-level signal and turned off by a low-level signal. Therefore, this high-level signal is referred to as the drive signal. If the drive signal is supplied to the pixel, the signal stored in the conversion element of the pixel is brought into a state where the signal can be read by the readout circuit 160. In a case where the driving line 110 is connected to at least one of the detection pixel 104 and the correction pixel 107, the driving line 110 is referred to as a detection driving line 111.

The readout circuit 160 is configured to read signals from the plurality of pixels through the plurality of signal lines 120. The readout circuit 160 includes a plurality of amplifiers 161, a multiplexer 162, and an analog-to-digital converter (AD converter) 163. Each of the plurality of signal lines 120 is connected to a corresponding amplifier 161 of the plurality of amplifiers 161 of the readout circuit 160. One signal line 120 corresponds to one amplifier 161. The multiplexer 162 selects a plurality of amplifier 161 in a predetermined order, and supplies a signal from the selected amplifier 161 to the AD converter 163. The AD converter 163 converts the supplied signal into a digital signal and outputs it.

The signal read from the imaging pixel 101 by the readout circuit 160 is supplied to the signal processing unit 170, and processing such as calculation and storage is performed by the signal processing unit 170. The signal processing unit 170 includes a calculating unit 171 and a storage 172. The calculating unit 171 generates a radiation image based on the signal read from the imaging pixel 101, and supplies the radiation image to the controlling unit 180. The storage 172 can store the read signal and the generated radiation image.

The signal read from the detection pixel 104 and the correction pixel 107 by the readout circuit 160 are supplied to the signal processing unit 170, and processing such as calculation and storage is performed by the signal processing unit 170. Specifically, the signal processing unit 170 outputs information indicating the irradiation of radiation with respect to the radiation imaging apparatus 100 based on the signals read from the detection pixel 104 and the correction pixel 107. For example, the signal processing unit 170 detects the irradiation of radiation with respect to the radiation imaging apparatus 100, and determines irradiation amount and/or dose (cumulative arrived-dose) D of the radiation. Further, the signal processing unit 170 can use the signal read from the detection pixel 104 together with the signal read from the imaging pixel 101 to generate the radiation image. Further, the signal processing unit 170 may use the signal read from the correction pixel 107 together with these signals to generate the radiation image. The storage 172 can also store the signals read from these pixels.

The controlling unit 180 controls the driving circuit 150 and the readout circuit 160 based on information from the signal processing unit 170. The controlling unit 180 controls, for example, the start and end of exposure (accumulation of charges, which corresponds to the irradiated radiation, by the imaging pixel 101) based on the information from the signal processing unit 170.

In order to determine the irradiation amount of radiation, the controlling unit 180 controls the driving circuit 150 to scan only the detection driving line 111 and set a state in which only the signals from the detection pixel 104 and the correction pixel 107 can be read. Next, the controlling unit 180 controls the readout circuit 160 to read signals from columns corresponding to the detection pixel 104 and the correction pixel 107 and output them as information indicating the irradiation amount of radiation. By such an operation, the radiation imaging apparatus 100 can obtain the irradiation information in the detection pixel 104 during the radiation irradiation.

FIG. 1B is a diagram for illustrating an example of the detailed circuit configuration of the amplifier 161. The amplifier 161 includes a differential amplifier circuit AMP and a sample-and-hold circuit SH. The differential amplifier circuit AMP amplifies and outputs a signal appearing on the signal line 120. The controlling unit 180 can reset the potential of the signal line 120 by supplying the control signal R to the switch element of the differential amplifier circuit AMP. The output from the differential amplifier circuit AMP can be held by the sample-and-hold circuit SH. The controlling unit 180 causes the sample-and-hold circuit SH to hold the signal by supplying the control signal φSH to the switch element of the sample-and-hold circuit SH. The signal held by the sample-and-hold circuit SH is read out by the multiplexer 162.

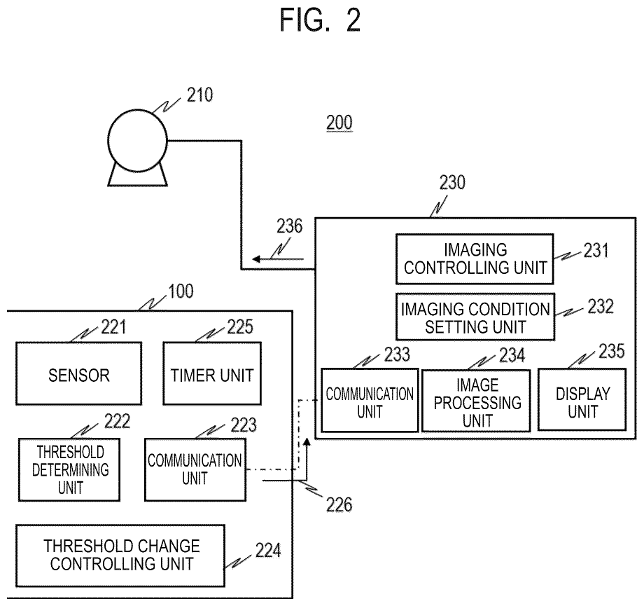

Next, the configuration of a radiation imaging system according to the first embodiment will be described with reference to FIG. 2. FIG. 2 is a diagram for illustrating an example of the schematic configuration of a radiation imaging system 200 according to the first embodiment. In the first embodiment, the radiation imaging system 200 can be particularly used for medical purposes. However, the radiation imaging system 200 may be used for other purposes, such as non-destructive inspection. The radiation imaging system 200 includes a radiation generating apparatus 210 for generating the radiation, the radiation imaging apparatus 100 for detecting the radiation and generating radiation image, and a controlling apparatus 230 for controlling the operations of the radiation generating apparatus 210 and the radiation imaging apparatus 100.

The radiation generating apparatus 210 irradiates the radiation toward a subject (not shown) based on the control by the controlling apparatus 230 (specifically, an imaging controlling unit 231). The radiation generating apparatus 210 includes, for example, a radiation tube, which is an example of a radiation generating unit that generates a radiation, and a collimator that defines a beam spread angle of the radiation generated by the radiation tube.

The radiation imaging apparatus 100 may include, for example, an FPD. The radiation imaging apparatus 100 includes the sensor 221, a threshold determining unit 222, a communication unit 223, a threshold change controlling unit 224, and a timer unit 225.

The sensor 221 includes, as described above, the imaging pixel 101, the detection pixel 104, and the correction pixel 107 distributed in two dimensions. The sensor 221 detects an incident radiation irradiated from the radiation generating apparatus 210. The radiation imaging apparatus 100 detects information (dose information) of the two-dimensional distribution of the dose of the radiation that has arrived at the imaging element (conversion element) in the sensor 221, and can generate the radiation image data. Thereafter, the radiation imaging apparatus 100 transmits the generated radiation image data to the controlling apparatus 230 via the communication unit 223. The controlling apparatus 230 can obtain and process the radiation image data imaged by the radiation imaging apparatus 100.

The threshold determining unit 222 uses the dose information detected by the sensor 221 to determine whether the dose of radiation has reached a threshold. The threshold determining unit 222 calculates the dose (cumulative arrived-dose) of radiation detected by the sensor 221, and if it is determined that the dose of radiation has reached the threshold, the threshold determining unit 222 causes the controlling unit 180 to stop reading the signal indicating the dose from the detection pixel 104.

If it is determined that the dose of radiation has reached the threshold, or if the dose of radiation has reached the threshold and waiting time has elapsed, the threshold determining unit 222 transmits (outputs) an irradiation stop signal 226 to the controlling apparatus 230 through the communication unit 223. If the controlling apparatus 230 receives the irradiation stop signal 226 (irradiation stop notification) from the radiation imaging apparatus 100 via a communication unit 233, an imaging controlling unit 231 of the controlling apparatus 230 performs irradiation stop control to stop the irradiation of radiation from the radiation generating apparatus 210. Specifically, the imaging controlling unit 231 transmits an irradiation stop signal 236 to the radiation generating apparatus 210 to perform the irradiation stop control. At the same time, the imaging controlling unit 231 returns a response indicating the reception of the irradiation stop signal 226 to the radiation imaging apparatus 100 via the communication unit 233. If the radiation imaging apparatus 100 does not receive the response for a certain period of time after transmitting the irradiation stop signal 226, the radiation imaging apparatus 100 can retransmit the irradiation stop signal 226 to the controlling apparatus 230.

The threshold determining unit 222 can hold an irradiation start threshold for detecting the start of irradiation in addition to the threshold for transmitting the irradiation stop signal 226. If the dose detected by the sensor 221 reaches the irradiation start detection threshold, the threshold determining unit 222 transmits that fact to the threshold change controlling unit 224.

The threshold change controlling unit 224 controls the change of the threshold for transmitting the irradiation stop signal. When the threshold determining unit 222 transmits that the dose has reached the irradiation start threshold, the threshold change controlling unit 224 determines that the point in time as the threshold change reference point. The threshold change controlling unit 224 changes the threshold for transmitting the irradiation stop signal based on the elapsed time from the threshold change reference point while referring to the counter of timer unit 225.

The communication unit 223 may be configured using any communication interface and can communicate with the controlling apparatus 230 by a wired manner or a wireless manner. Prior to the imaging, the radiation imaging apparatus 100 communicates with the communication unit 233 of the controlling apparatus 230 via the communication unit 223, and the communication response time between the two apparatuses can be counted by timer unit 225. The threshold change controlling unit 224 calculates delay time due to the communication based on the counted communication response time, and holds communication delay time TDc. The threshold change controlling unit 224 reflects the calculated communication delay time TDc to the threshold setting.

The threshold determining unit 222, the threshold change controlling unit 224, and the timer unit 225 may be included in the controlling unit 180. The calculating unit 171, the controlling unit 180, the threshold determining unit 222, the threshold change controlling unit 224, and the timer unit 225 can be configured using one or more any processors and programs read from storage (not shown). The processor may be, for example, a central processing unit (CPU) or a micro processing unit (MPU). The processor may be a graphical processing unit (GPU) or a field-programmable gate array (FPGA). Alternatively, these components may be configured by circuits that perform specific functions, such as ASICs. The storage 172 and a storage (not shown) for storing programs may be configured by using any memory, optical disk, SSD (Solid State Drive), or any other storage medium.

Next, the controlling apparatus 230 will be described. The controlling apparatus 230 includes an imaging controlling unit 231, an imaging condition setting unit 232, a communication unit 233, an image processing unit 234, and a display unit 235. The imaging controlling unit 231 controls radiation imaging using the radiation generating apparatus 210 and the radiation imaging apparatus 100. The controlling apparatus 230 can communicate with the radiation imaging apparatus 100 via the communication unit 233. The controlling apparatus 230 is connected to the radiation generating apparatus 210, and the imaging controlling unit 231 can transmit the irradiation stop signal 236 to the radiation generating apparatus 210 to stop the irradiation of radiation from the radiation generating apparatus 210, thereby performing irradiation stop control.

The imaging condition setting unit 232 sets imaging-condition data including, for example, imaging-condition information input by the operator. The imaging-condition may include, for example, an imaged site in subject, a tube voltage and a tube current in the radiation generating apparatus 210, a target value Dref of the dose (cumulative arrived-dose) of the radiation which passes through the subject and reaches the radiation imaging apparatus 100, and the like. The dose generally means the cumulative arrived-dose at the time of the radiation irradiation, and in the following, the cumulative arrived-dose is used as the dose. However, as the value of dose, a value of dose similar to the cumulative arrived-dose or a value of dose linked to the cumulative arrived-dose may be used.

The communication unit 233 may be configured using any communication interface, and can communicate with radiation imaging apparatus 100 by a wired manner or a wireless manner.

The image processing unit 234 can perform image processing such as gradation processing or noise reduction processing on the radiation image data transmitted from the radiation imaging apparatus 100. The image processing unit 234 can transmit the radiation image data after the image processing to the display unit 235.

The display unit 235 can include any monitor or the like, and can display the radiation image based on the radiation image data transmitted from the image processing unit 234 and the like on the monitor. The display unit 235 may include a monitor or the like connected to the controlling apparatus 230, or may include a monitor or the like integrated with the controlling apparatus 230.

The controlling apparatus 230 may comprise a computer provided with a processor and a memory. The controlling apparatus 230 may be configured by a general computer or a computer dedicated to the radiation imaging system.

The components other than display unit 235 of the controlling apparatus 230 may be configured by using, for example, one or more processors such as CPUs and a program read from the storage (not shown). The processor may be, for example, an MPU, a GPU, an FPGA, or the like. The components other than display unit 235 of the controlling apparatus 230 may be configured by an integrated circuit that performs a specific function such as an ASIC. The internal configuration of the controlling apparatus 230 may include a graphic controlling unit such as a GPU, and an input/output controlling unit such as a keyboard, a display, or a touch panel. The storage (not shown) may be configured by using any memory, any storage medium such as an optical disk, or an SSD.

The timing at which the irradiation stop signal 226 is transmitted from the radiation imaging apparatus 100 to the controlling apparatus 230 according to the first embodiment may be determined by taking into account delay time until the irradiation of radiation stops in addition to communication delay time. Here, the communication delay time is delay time associated with communication when the irradiation stop signal 226 is transmitted from the radiation imaging apparatus 100 to the controlling apparatus 230. The delay time until the irradiation of radiation stops is delay time from when the controlling apparatus 230 transmits the irradiation stop signal 236 for stopping the irradiation of radiation to when the irradiation of radiation stops at the radiation generating apparatus 210.

The time when the irradiation of radiation stops at the radiation generating apparatus 210 is the time when the tube voltage in the radiation tube of the radiation generating apparatus 210 starts to drop or the time when the tube voltage completely drops. Here, in a case where the delay time is set based on the time when the tube voltage completely drops, the delay time can be set by taking into account the time obtained by multiplying a non-stationary period from when the tube voltage in the radiation tube starts to drop to when the tube voltage completely drops by a coefficient in consideration of changes in the dose and the quality of the radiation. More specifically, the delay time TD includes a stationary period Ta from the time of the signal transmission to when the tube voltage starts to drop, and a non-stationary period Tb from when the tube voltage starts to drop to when the tube voltage completely drops. At this time, the non-stationary period Tb is multiplied by a coefficient k (where the coefficient k is less than or equal to 1) because the tube voltage in the radiation tube decreases, and added to the stationary period Ta. That is, the delay time TD if the non-stationary period Tb is added can be determined based on the following equation.

$$TD = Ta + k T b$$

In this embodiment, the delay time TD can be obtained for each radiation generating apparatus before the irradiation of radiation in the radiation imaging of the subject (i.e., before imaging). As the delay time TD, a value actually measured when the radiation imaging apparatus 100 is installed can be used. Furthermore, the imaging environment and the radiation generating apparatus 210 to be used may be registered in a database in advance, and the delay time TD may be calculated by referring to the database. The threshold change controlling unit 224 may obtain the delay time TD in advance, and set the threshold value in consideration of the delay time TD.

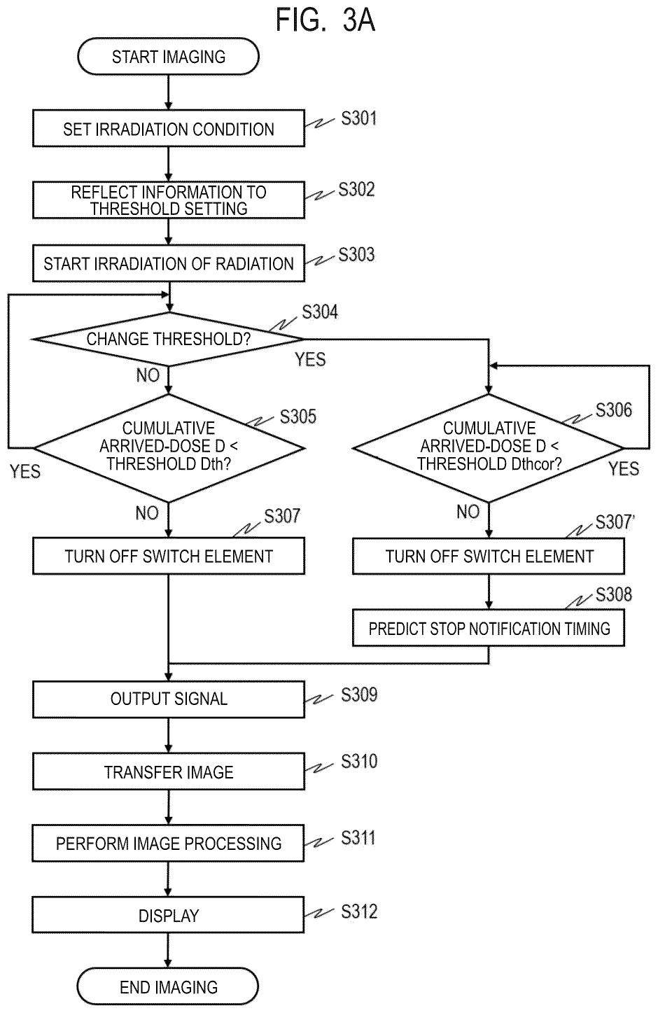

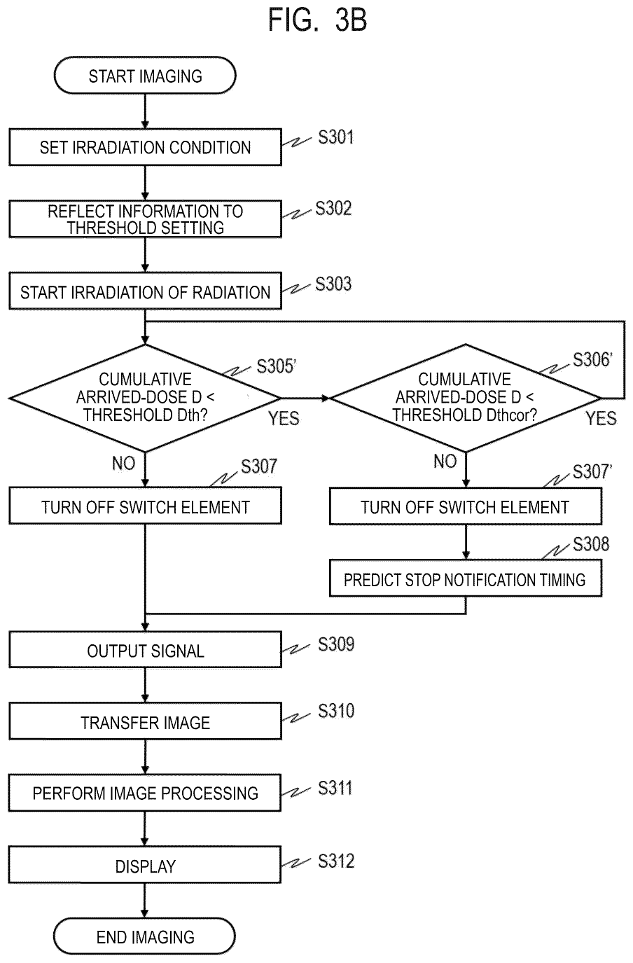

FIG. 3A is a flowchart showing an example of a processing procedure in a series of control method from the start to the end of the imaging of the subject in the radiation imaging system 200 according to the first embodiment. In the imaging processing according to the first embodiment, a threshold value Dth of the dose (cumulative arrived-dose), the time variation of the threshold value Dth, and a threshold value Dthcor of the dose necessary for correcting the radiation image are set, and the radiation imaging of the subject is performed. Specifically, the threshold change controlling unit 224 sets the threshold value Dth, the time variation of the threshold value Dth, and the dose threshold value Dthcor based on the delay time TD held in advance, the communication delay time TDc obtained in advance, and the dose target value Dref.

First, in step S301, the imaging condition setting unit 232 receives an instruction of the start of imaging input by the operator via the input unit (not shown), and sets, for example, the imaging-condition information (irradiation condition information) corresponding to the instruction from the operator. Here, as the imaging-condition information, the imaging condition setting unit 232 sets the tube voltage and the tube current in the radiation tube, the target value Dref of the dose, the delay time TD, and the threshold value Dthcor. Thereafter, the imaging condition setting unit 232 transmits the obtained instruction of the imaging start and the set imaging-condition information to the radiation imaging apparatus 100. The values of the delay time TD and/or the threshold Dthcor may be stored in any apparatus constituting the radiation imaging system 200, and the imaging condition setting unit 232 may refer to the stored values. Further, the threshold Dthcor of dose necessary for the correction of radiation image may be determined, for example, by a rate of the target value Dref (e.g., 60% of the target value Dref), or may be determined by an absolute value based on dose information necessary for the correction of radiation image.

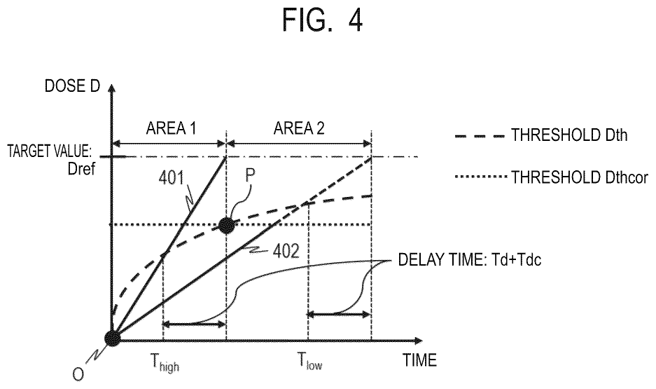

Subsequently, in step S302, the threshold change controlling unit 224 sets the dose threshold Dth, the time variation of the dose threshold Dth, and the threshold Dthcor based on the dose target value Dref, the delay time TD, and the communication delay time TDc set in step S301. The setting of the dose threshold Dth and the time variation of the dose threshold Dth, and the setting of the threshold Dthcor will be described later with reference to FIG. 4.

Subsequently, in step S303, the imaging controlling unit 231 transmits an irradiation execution signal for irradiating the radiation together with the imaging-condition information received from the imaging condition setting unit 232 in step S301 to the radiation generating apparatus 210. In accordance with this processing, the radiation generating apparatus 210 irradiates the radiation to the subject with the irradiation condition based on the imaging-condition information received from the imaging condition setting unit 232.

Subsequently, in step S304, the threshold change controlling unit 224 changes the threshold to be compared with the dose in accordance with elapsed time from the threshold change reference point. More specifically, the threshold change controlling unit 224 changes the threshold to be compared with the dose from the threshold Dth to the threshold Dthcor if the threshold Dth which varies with time is greater than the threshold Dthcor at the elapsed time. In step S304, if the threshold Dth which varies with time is equal to or smaller than the threshold Dthcor at the elapsed time, the threshold change controlling unit 224 determines that the threshold to be compared with the dose is not changed from the threshold Dth, and the process proceeds to step S305. On the other hand, if the threshold Dth which varies with time is greater than the threshold Dthcor at the elapsed time, the threshold change controlling unit 224 determines that the threshold to be compared with the dose is changed from the threshold Dth to the threshold Dthcor, and the process proceeds to step S306.

In step S305, first, the threshold determining unit 222 calculates a value representative of the dose of the radiation detected by the sensor 221, and calculates a cumulative value of the values representative of the dose of radiation. As the value representative of the dose of radiation, a maximum value, an average value, a median value, or the like of the dose may be used. In the following description, the cumulative value of the values representative of the dose of radiation will be described as cumulative arrived-dose D. Hereinafter, however, the value of dose to be compared with the threshold Dth or the threshold Dthcor of the dose is not limited to the cumulative arrived-dose D, but may be dose similar to the cumulative arrived-dose or a value linked to the cumulative arrived-dose.

The threshold determining unit 222 compares the calculated cumulative arrived-dose D with the threshold Dth set in step S302, and determines whether or not the cumulative arrived-dose D is smaller than the threshold Dth. As a result of this determination, if the cumulative arrived-dose D is smaller than the threshold Dth (step S305/YES), the process proceeds to step S304. On the other hand, as a result of the determination in step S305, if the cumulative arrived-dose D is not smaller than the threshold Dth (the cumulative arrived-dose D is equal to or greater than the threshold Dth) (step S305/NO), the process proceeds to step S307.

In step S306, first, the threshold determining unit 222 calculates a value representative of the dose of the radiation detected by the sensor 221, and calculates an accumulated value of the values representative of the dose of radiation. The method of calculating the accumulated value of the values representative of the dose of radiation may be the same as the method in step S305. The threshold determining unit 222 compares the calculated cumulative arrived-dose D with the threshold Dthcor set in step S302, and determines whether or not the cumulative arrived-dose D is smaller than the threshold Dthcor. As a result of this determination, if the cumulative arrived-dose D is smaller than the threshold Dthcor (step S306/YES), the process repeats step S306. On the other hand, as a result of the determination in step S306, if the cumulative arrived-dose D is not smaller than the threshold Dthcor (the cumulative arrived-dose D is equal to or greater than the threshold Dthcor) (step S306/NO), the process proceeds to step S307′.

In step S307, since the cumulative arrived-dose D exceeds (reaches) the threshold value Dth, the threshold determining unit 222 performs a stop instruction to cause the controlling unit 180 to stop the readout operation. Upon receiving the stop instruction, the controlling unit 180 causes the driving circuit 150 to stop the output of the drive signal to the pixel to be driven. As a result, the switch element of the pixel to be driven is turned off, and the accumulation operation of the dose information is started. If the output of the drive signal is stopped, the process proceeds to step S309.

On the other hand, in step S307′, since the cumulative arrived-dose D exceeds (reaches) the threshold value Dthcor, the threshold determining unit 222 performs stop instruction to cause the controlling unit 180 to stop the readout operation. Upon receiving the stop instruction, the controlling unit 180 causes the driving circuit 150 to stop the output of the drive signal to the pixel to be driven. As a result, the switch element of the pixel to be driven is turned off, and the accumulation operation of the dose information is started. If the output of the drive signal is stopped, the process proceeds to step S308.

In step S308, since the pixel to be driven is performing the accumulation operation, the detected dose of radiation is not read out, and therefore the cumulative arrived-dose D calculated based on the read dose is not increased. However, in actuality, since the radiation continues to be irradiated, the actual cumulative arrived-dose D increases with the passage of time. Therefore, in step S308, the threshold determining unit 222 predicts the timing at which the cumulative arrived-dose D that has actually arrived at the sensor 221 reaches the threshold Dth based on the cumulative arrived-dose D that has been calculated and the elapsed time from the threshold change reference point. In other words, the threshold determining unit 222 predicts the timing to output the irradiation stop signal 226 for stopping the irradiation of radiation from the radiation generating apparatus 210. Details of the prediction method will be described later with reference to FIG. 4. If the predicted timing is reached, the process proceeds to step S309.

In step S309, since the cumulative arrived-dose D exceeds (reaches) or is predicted to exceed the threshold Dth, the radiation imaging apparatus 100 transmits the irradiation stop signal 226 to the controlling apparatus 230 via the communication unit 223. If the controlling apparatus 230 receives the irradiation stop signal, the imaging controlling unit 231 transmits the irradiation stop signal 236 to the radiation generating apparatus 210 to perform the irradiation stop control.

At this time, it takes the communication delay time TDc to transmit the irradiation stop signal 226 from the radiation imaging apparatus 100 to the controlling apparatus 230. Furthermore, after the imaging controlling unit 231 transmits the irradiation stop signal 236 to the radiation generating apparatus 210, it takes the delay time TD until the irradiation of radiation actually stops at the radiation generating apparatus 210. Therefore, the irradiation of radiation continues during the communication delay time TDc and the delay time TD. In this regard, the threshold value Dth is a threshold value set in consideration of the communication delay time TDc and the delay time TD. Therefore, by transmitting the irradiation stop signal in step S309, the radiation irradiated during the communication delay time TDc and the delay time TD can bring the cumulative arrived-dose D actually irradiated closer to the target value Dref of the cumulative arrived-dose D.

Subsequently, in step S310, the driving circuit 150 controls the imaging element in the sensor 221 and stops the conversion to the dose information. The calculating unit 171 of the signal processing unit 170 generates the radiation image data using the signal read out by the readout circuit 160. The controlling unit 180 transmits the generated radiation image data to the controlling apparatus 230 via the communication unit 223.

In step S311, the image processing unit 234 of the controlling apparatus 230 performs image processing such as gradation processing and noise reduction processing on the radiation image data received from the radiation imaging apparatus 100. Then, the image processing unit 234 transmits the radiation image data after the image processing to the display unit 235.

In step S312, the display unit 235 outputs the radiation image based on the radiation image data received from the image processing unit 234 to a monitor or the like to display it, and presents the radiation image to the operator. If the processing of step S312 is completed, the processing of the flowchart of the radiation imaging of the subject shown in FIG. 3A is completed.

Next, with reference to FIG. 4, the processing of setting the threshold value Dth of the cumulative arrived-dose, the time variation of the threshold value Dth, and the threshold value Dthcor in step S302 in FIG. 3A will be described. When setting the time variation of the threshold value Dth of the cumulative arrived-dose, if the affirmative determination (YES in step S305) is made in step S305, the threshold change controlling unit 224 performs the same processing as that of setting the threshold value Dth in step S302.

FIG. 4 is a diagram for illustrating an example of the relationship among the threshold value Dth, the time variation of the threshold value Dth, and the threshold value Dthcor, and the cumulative arrived-dose D according to the first embodiment. FIG. 4 shows a relationship between the dose D (the cumulative arrived-dose D) shown on the vertical axis and the time (the elapsed time) shown on the horizontal axis.

First, the threshold value Dth and the time variation of the threshold value Dth will be described. As shown in FIG. 4, the threshold change controlling unit 224 performs control to change the threshold value Dth in accordance with the elapsed time from the start of the irradiation of radiation. As an example, as shown in FIG. 4, the threshold change controlling unit 224 performs control to increase the threshold value Dth in accordance with the elapsed time. Here, the starting point for measuring the elapsed time is the threshold change reference point O shown in FIG. 4.

As for the threshold change reference point O, as described above, when the threshold determining unit 222 determines that the cumulative arrived-dose D detected by sensor 221 has reached the irradiation start threshold, the threshold determining unit 222 notifies the threshold change controlling unit 224 of the time point as the threshold change reference point O. In the first embodiment, it is assumed that the cumulative arrived-dose D detected by the sensor 221 is used to determine whether the cumulative arrived-dose D has reached the irradiation start threshold when the threshold change reference point O is determined. On the other hand, if the signal-to-noise ratio (S/N ratio) of the dose detected by the sensor 221 is sufficiently high, the threshold determining unit 222 may use dose per one sample instead of the arrived dose to determine whether the irradiation start threshold has been reached.

The threshold change controlling unit 224 counts the elapsed time from the threshold change reference point O by using the timer unit 225, and performs the control to change (increase) the threshold Dth in accordance with the elapsed time. In the first embodiment, as shown in FIG. 4, the threshold Dth is continuously changed with respect to elapsed time as the time variation of the threshold Dth, but for example, the threshold Dth may be expressed by a step function that changes stepwise with respect to the elapsed time in consideration of the memory capacity. In this case, the length of the time section of the step function related to the threshold Dth may be different for each time section.

In the first embodiment, the threshold Dth for the elapsed time T can be set as satisfying the following equation (1) by using the elapsed time T, the delay time TD, the communication delay time TDc, and the target value Dref of the cumulative arrived-dose.

$$Dth ( T ) = T / ( T + ( T D + T D c ) ) \times Dref \qquad Equation ( 1 )$$

That is, as shown in the equation (1), the threshold change controlling unit 224 can change the threshold Dth according to the elapsed time T and set the time variation of the threshold Dth based on the target value Dref, the delay time TD, and the communication delay time TDc. If the step function is used as the threshold Dth, it is possible to set a function such that each step of the steps and the equation (1) intersect.

Next, the processing of setting the threshold Dthcor will be described. As shown in FIG. 4, the threshold change controlling unit 224 according to the first embodiment sets the threshold Dthcor as a certain value. As described above, the threshold Dthcor may be determined based on a predetermined ratio of the target value Dref or the like, and in the example shown in FIG. 4, the threshold Dthcor intersects the threshold Dth at the position of the point P.

The threshold Dthcor may be determined such that the dose information necessary for the radiation image correction remains in the detection pixel 104. For example, the threshold Dthcor may be determined based on a correction limit such that the generated radiation image has an acceptable S/N ratio in terms of image quality with respect to the relationship of the S/N ratio. More specifically, the threshold Dthcor may be determined by a rate of the target value Dref from an acceptable S/N ratio based on the noise amount N and the target value Dref.

The threshold Dthcor may vary with time, such as the threshold Dth. In such a case, for example, the threshold Dthcor may be set to decrease with time as a linear expression of time. Further, the threshold value Dthcor may be set to decrease in accordance with time as a linear expression of time in consideration of the S/N ratio. In these cases, the longer the irradiation time, the more dose information remains in the detection pixel 104, and the deterioration of the S/N ratio due to, for example, temperature drift or the like can be suppressed. Furthermore, the threshold value Dthcor may be set to be constant or to vary with time up to or from a predetermined time.

Next, a specific threshold determination method (a determination method of a stop notification) using the threshold value Dth and the threshold value Dthcor will be described. First, in FIG. 4, an area from the threshold change reference point O to the point P is defined as an area 1 and an area after the point P is defined as an area 2 on the basis of a time axis with the point P as a boundary. In such a case, the threshold value Dth≤the threshold value Dthcor in the area 1, and the threshold value Dth>the threshold value Dthcor in the area 2.

First, the operation of radiation imaging apparatus 100 related to the threshold determination method in the area 1 will be described. Since the threshold value Dth≤the threshold value Dthcor in the area 1, the threshold determining unit 222 determines whether the cumulative arrived-dose D detected by the sensor 221 is equal to or greater than the threshold value Dth which varies with the elapsed time shown in FIG. 4. If the cumulative arrived-dose D becomes equal to or greater than the threshold value Dth (step S305/NO), the threshold determining unit 222 performs the stop instruction to cause the controlling unit 180 to stop the readout operation in step S307 in FIG. 2. Specifically, the controlling unit 180 having received the stop instruction causes the driving circuit 150 to stop the output of the drive signal to the pixel to be driven. As a result, the switching element of the pixel to be driven is turned off, and the accumulation operation of the dose information is started.

Then, the radiation imaging apparatus 100 transmits the irradiation stop signal 226 to the controlling apparatus 230. Upon receiving the irradiation stop signal 226, the imaging controlling unit 231 performs the irradiation stop control by transmitting the irradiation stop signal 236 to the radiation generating apparatus 210 so as to stop the irradiation of radiation from the radiation generating apparatus 210. At this time, the irradiation of radiation continues for the communication delay time TDc and the delay time TD.

In the example shown in FIG. 4, if the radiation having a high dose rate enters the radiation imaging apparatus 100, the cumulative arrived-dose 401 is equal to or greater than the threshold value Dth at irradiation time Thigh. As a result, at the irradiation time Thigh, the radiation imaging apparatus 100 transmits the irradiation stop signal 226 to the controlling apparatus 230, and then the irradiation of radiation is stopped at the radiation generating apparatus 210 at the time when the cumulative arrived-dose 401 becomes the target value Dref.

Since the threshold value Dth is a threshold value in consideration of the dose corresponding to the communication delay time TDc and the delay time TD, the radiation of the target value Dref arrives at the radiation imaging apparatus 100 when the irradiation of radiation from the radiation generating apparatus 210 actually stops. Therefore, in the area 1, the transmission of the irradiation stop notification signal and the stop of the output of the drive signal for the pixel to be driven are performed by using the threshold value Dth.

Further, the dose information corresponding to the radiation output irradiated after the switch element 106 of the detection pixel 104 is turned off until the irradiation stops can be accumulated in the detection pixel 104. In a case where the cumulative arrived-dose D reaches the threshold value Dth in the area 1, the radiation irradiated to the radiation imaging apparatus 100 is radiation with a relatively high dose rate. Therefore, even if the irradiation stop signal 226 is transmitted at the irradiation time Thigh when the cumulative arrived-dose D is equal to or greater than the threshold value Dth, the dose information accumulated in the detection pixel 104 until the irradiation of radiation stops becomes a sufficient amount to be used for the radiation image correction. For this reason, the calculating unit 171 of the radiation imaging apparatus 100 can correct the pixel using the dose information accumulated in the detection pixel 104, thereby achieving pixel output correction with higher accuracy than when the information is defect.

Next, the operation of the radiation imaging apparatus 100 related to the threshold determination method in the area 2 will be described. In the area 2, since the threshold Dth>the threshold Dthcor, the cumulative arrived-dose D reaches the threshold Dthcor before the threshold Dth. Therefore, in the area 2, the threshold determining unit 222 determines whether the cumulative arrived-dose D detected by the sensor 221 is equal to or greater than the certain threshold Dthcor shown in FIG. 4. If the cumulative arrived-dose D becomes equal to or greater than the threshold Dthcor (step S306/NO), the threshold determining unit 222 performs the stop instruction to cause the controlling unit 180 to stop the readout operation in step S307′ in FIG. 2. Specifically, the controlling unit 180 having received the stop instruction causes the driving circuit 150 to stop the output of the drive signal to the pixel to be driven. As a result, the switching element of the pixel to be driven is turned off, and the accumulation operation of the dose information is started.

Then, the threshold determining unit 222 predicts the timing when the stop notification signal of the radiation is to be output. For example, the threshold determining unit 222 can calculate a gradient (linear approximation formula) of the cumulative arrived-dose which varies with time by using the cumulative arrived-dose D and the time information (the elapsed time) from the threshold change reference point O at the time when the cumulative arrived-dose D reaches the threshold Dthcor. Thereafter, the threshold determining unit 222 can calculate the remaining time (waiting time) up to the intersection point of the linear approximation formula of the cumulative arrived-dose and the threshold Dth using the calculated gradient information.

Converting such processing into a mathematical expression, the waiting time Twait is expressed from the elapsed time T, the target value Dref, the delay time TD, and the communication delay time TDc as shown in the following equation (2).

$$Twait = ( Dref - D ( T ) ) / ( D ( T ) / T ) - ( T D + T Dc ) \qquad Equation ( 2 )$$

After the cumulative arrived-dose D reaches the threshold Dthcor, the radiation imaging apparatus 100 waits by the waiting time Twait and transmits the irradiation stop signal 226 to the controlling apparatus 230. Upon receiving the irradiation stop signal 226, the imaging controlling unit 231 performs the irradiation stop control by transmitting the irradiation stop signal 236 to the radiation generating apparatus 210 to stop the irradiation of radiation from the radiation generating apparatus 210. At this time, the irradiation of radiation continues for the communication delay time TDc and the delay time TD.

In the example shown in FIG. 4, if the radiation having a low dose rate enters the radiation imaging apparatus 100, the cumulative arrived-dose 402 reaches threshold Dth at irradiation time T_{low}. However, when the cumulative arrived-dose 402 reaches threshold Dthcor, the accumulation operation of the detection pixel 104 is started, and the cumulative arrived-dose 402 to be detected does not vary with time. Therefore, the threshold determining unit 222 predicts the timing when the cumulative arrived-dose, which has actually arrived at the sensor 221, reaches the threshold Dth, and calculates waiting time Twait until the timing. Since the cumulative arrived-dose that actually arrives at the sensor 221 after the lapse of the waiting time Twait is equal to or greater than the threshold value Dth, the radiation imaging apparatus 100 transmits the irradiation stop signal 226 to the controlling apparatus 230 at the time of the irradiation time T_{low}. Then, the imaging controlling unit 231 performs the irradiation stop control, and the irradiation of radiation is stopped at the radiation generating apparatus 210.

As described above, the threshold value Dth is a threshold value in consideration of the dose corresponding to the communication delay time TDc and the delay time TD. Therefore, if the irradiation stop signal 226 is transmitted at the predicted timing when the cumulative arrived-dose reaches the threshold value Dth, the radiation of the target value Dref arrives at the radiation imaging apparatus 100 at the time when the irradiation from the radiation generating apparatus 210 actually stops.

As shown in FIG. 4, the dose information accumulated in the detection pixel 104 increases or decreases based on the relationship between the time and the dose rate of the radiation associated with the cumulative arrived-dose 401 or the cumulative arrived-dose 402. In FIG. 4, for example, if only the threshold value Dth is used, the actual cumulative arrived-dose D varies according to the difference in the dose rate and, in the case of a low dose rate, the dose information that can be accumulated in the detection pixel 104 decreases (for example, such a dose information becomes the difference of the target value Dref and the dose at the irradiation time T_{low}). For this reason, the dose information sufficient to be used for radiation image correction cannot be accumulated in the detection pixel 104, and the detection pixel 104 may output probability only dose information similar to that of pixels whose information is defect.

On the other hand, in the first embodiment, as shown in FIG. 4, the threshold change controlling unit 224 changes the threshold used for the threshold determination processing in the area 1 where the threshold Dth≤the threshold Dthcor and in the area 2 where the threshold Dth>the threshold Dthcor. More specifically, in the area 1, the threshold change controlling unit 224 sets the threshold used for the threshold determination processing to the threshold Dth. In this case, if the threshold determining unit 222 determines that the cumulative arrived-dose D is equal to or greater than the threshold Dth, the radiation imaging apparatus 100 simultaneously performs the stop of the drive signal of the switching element 106 of the detection pixel 104 and the output of the irradiation stop signal. On the other hand, in the area 2, the threshold change controlling unit 224 sets the threshold used for the threshold determination processing to the threshold Dthcor. In this case, if the threshold determining unit 222 determines that cumulative arrived-dose D is equal to or greater than the threshold Dthcor, the radiation imaging apparatus 100 stops the switching element 106 of the detection pixel 104 at the threshold Dthcor. Then, the threshold determining unit 222 predicts the timing when the cumulative arrived-dose D reaches the threshold Dth, and the radiation imaging apparatus 100 outputs the irradiation stop notification signal at the timing.

By such processing, in both the case of a high dose rate and the case of a low dose rate, the cumulative arrived-dose D that actually arrives at the sensor 221 can be brought close to the target value Dref with high accuracy, and sufficient dose information can remain in the detection pixel 104. Thus, regardless of the magnitude of dose rate, the irradiation stop control of radiation can be performed with high accuracy, and the degradation of image quality can be reduced by correcting the pixel value using the dose information remaining in the detection pixel 104.

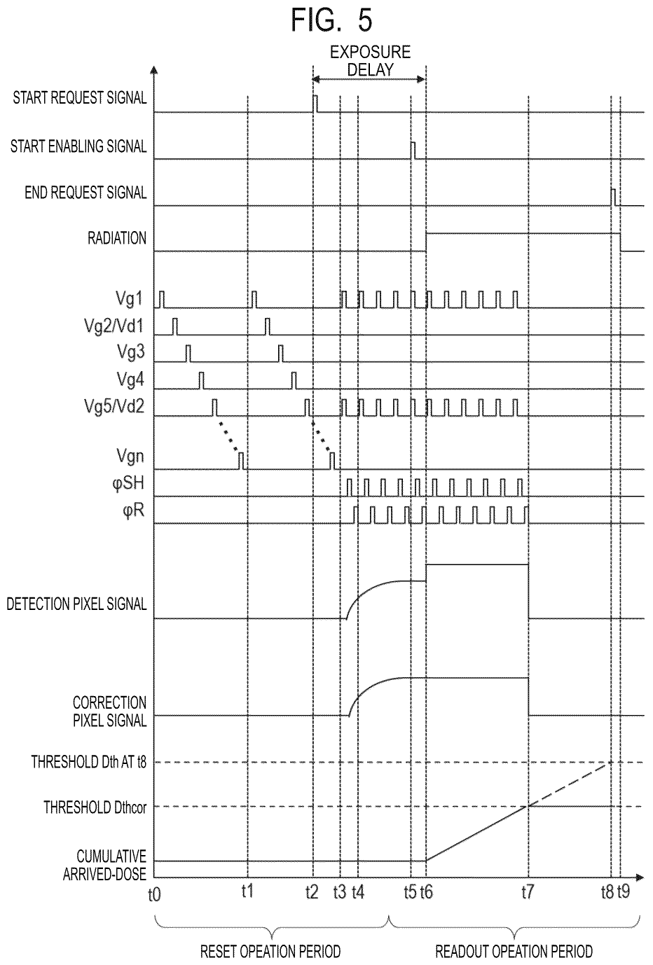

Next, an operation example of the radiation imaging apparatus 100 according to the first embodiment will be described with reference to FIG. 5. This operation is executed by cooperation between the signal processing unit 170 and the controlling unit 180 that controls the driving circuit 150 and the readout circuit 160. Therefore, a combination of the signal processing unit 170 and the controlling unit 180 may be called an exposure determining unit.

“RADIATION” in FIG. 5 indicates whether or not the radiation imaging apparatus 100 is irradiated with radiation. A low value indicates that the radiation is not irradiated, and a high value indicates that the radiation is irradiated. “Vg1” to “Vgn” indicate drive signals supplied from the driving circuit 150 to each of the plurality of driving lines 110 (1 to n). “Vgk” corresponds to the driving line 110 in the k-th row (k=1, . . . , n (the total number of the drive wires)). As described above, a part of the plurality of driving lines 110 is also called the detection driving line 111. The j-th detection driving line 111 is denoted as “Vdj” (j=1, . . . , m (the total number of the detection driving lines)). “φSH” indicates the level of the control signal supplied to the sample-and-hold circuit SH of the amplifier 161. “φR” indicates the level of the control signal supplied to the differential amplifier circuit AMP of the amplifier 161.

“DETECTION PIXEL SIGNAL” in FIG. 5 indicates the value of the signal read from the detection pixel 104. “CORRECTION PIXEL SIGNAL” indicates the value of the signal read from the correction pixel 107. “CUMULATIVE ARRICED-DOSE” indicates an integrated value of the radiation irradiated to the radiation imaging apparatus 100. This integrated value is determined by calculation of the detection pixel signal and the correction pixel signal, but a detailed description thereof will be omitted in this embodiment. “THRESHOLD VALUE Dthcor” and “THRESHOLD VALUE Dth AT t8” indicate the above-described threshold value Dthcor and the threshold value Dth at time t8. The horizontal axis in FIG. 5 indicates time.

At time t0, the controlling unit 180 starts a reset operation of the plurality of pixels. The reset operation is an operation of removing the electric charge accumulated in the conversion element of each pixel, and more specifically, the reset operation means to bring the switching element of each pixel into a conductive state by supplying a drive signal to the driving line 110. The controlling unit 180 controls the driving circuit 150 to supply a drive signal Vg1 to the driving line 110 in the first row and reset each pixel connected to the driving line 110 in the first row. Subsequently, controlling unit 180 controls the driving circuit 150 to supply a drive signal Vg2 to the driving line 110 in the second row and reset each pixel connected to the driving line 110 in the second row. The controlling unit 180 repeats this operation up to the driving line 110 in the last row. At time t1, after the controlling unit 180 finishes the reset operation of the driving line 110 in the last row, the controlling unit 180 repeats the reset operation from the driving line 110 in the first row again.

At time t2, the controlling unit 180 receives a start request signal from the imaging controlling unit 231. In response to the reception of the start request signal, the controlling unit 180 ends the reset operation after performing the reset operation up to the last row. The controlling unit 180 may ends the reset operation before performing the reset operation up to the last row, and proceed to the next process. For example, if the controlling unit 180 receives the start request signal during the reset operation of the driving line 110 in the k-th row, the controlling unit 180 may proceed to the next process without performing the reset operation of the driving lines 110 in the k+1-th row and the subsequent rows. In this case, the level difference that may occur in the radiation image may be reduced by adjusting the drive for obtaining the radiation image by the controlling unit 180 or by performing image processing on the radiation image by the signal processing unit 170.

At time t3, the controlling unit 180 starts a determining operation for determining the amount of radiation being irradiated to the radiation imaging apparatus 100. The reading operation of signals related to the determining operation is performed for the detection driving line 111 and is not performed for the other driving lines 110. Specifically, the driving circuit 150 supplies a drive signal to the detection driving line 111, which is a driving line 110 connected to at least one of the detection pixel 104 and the correction pixel 107 among the plurality of driving lines 110. On the other hand, the driving circuit 150 does not supply a drive signal to a driving line 110 of the plurality of driving lines 110 that is not connected to either the detection pixel 104 or the correction pixel 107. Further, the driving circuit 150 simultaneously supplies drive signals to driving lines 110 connected to at least one of the detection pixel 104 and the correction pixel 107 among the plurality of driving lines 110. Thus, signals from a plurality of pixels connected to the same signal line 120 are combined and read out to the readout circuit 160. Since the detection pixel 104 and the correction pixel 107 are exclusively connected to the signal line 120, the readout circuit 160 can separate and read out the signals of pixels having different sensitivities.

In one readout operation, the controlling unit 180 performs an operation from time t3 to time t4. Specifically, the controlling unit 180 temporarily supplies drive signals to one or more detection driving lines 111. Then, the controlling unit 180 temporarily sets the control signal φSH to a high-level to hold the signal read from the pixel to the readout circuit 160 via the signal line 120 in the sample-and-hold circuit SH. Then, the controlling unit 180 temporarily sets the control signal φR to a high-level to reset the readout circuit 160 (specifically, the differential amplifier circuit AMP of the amplifier 161 thereof). In a case where a region of interest is set in the imaging region IR, a signal may not be read from the detection pixel 104 that is not included in the region of interest.

When the readout operation is completed one or more times, the controlling unit 180 transmits a start enabling signal to the radiation generating apparatus 210 at time t5. After time t5, the radiation generating apparatus 210 starts the irradiation of radiation from time t6.

The controlling unit 180 repeatedly executes the above-described readout operation after transmitting the start enabling signal. The threshold determining unit 222 measures the dose for each readout operation, and determines whether or not the cumulative arrived-dose D exceeds a threshold value. The threshold determining unit 222 determines that the irradiation of radiation has started if the cumulative arrived-dose D becomes equal to or greater than the irradiation start threshold value. Further, if the cumulative arrived-dose D becomes equal to or greater than the threshold value Dth or the threshold value Dthcor, the threshold determining unit 222 determines that the stop instruction is performed to controlling unit 180.

Time t7 is a timing at which the threshold determining unit 222 performs the stop instruction to stop the readout operation to the controlling unit 180 in step S307′. In the example shown in FIG. 5, since the cumulative arrived-dose reaches the threshold value Dthcor at time t7, the threshold determining unit 222 performs the stop instruction to the controlling unit 180. Upon receiving the stop instruction, the controlling unit 180 causes the driving circuit 150 to stop the output of the drive signal to the pixel to be driven. As a result, the switching element of the pixel to be driven is turned off, and the accumulation operation of the dose information is started. Therefore, the detection pixel signal, the correction pixel signal, and the cumulative arrived-dose do not vary with time.

The threshold determining unit 222 predicts time t8, which is the timing when the cumulative arrived-dose reaches the threshold Dth, based on the elapsed time between the time 6 and the time t7, the cumulative arrived-dose during the elapsed time, and the threshold Dth. If the controlling unit 180 determines that the cumulative arrived-dose D reaches the threshold Dth at the time t8 based on the prediction, the radiation imaging apparatus 100 transmits the irradiation stop signal 226 to the controlling apparatus 230 via the communication unit 223. The controlling apparatus 230, which has received the irradiation stop signal 226, transmits the irradiation stop signal 236 for stopping the irradiation of radiation to the radiation generating apparatus 210.

The irradiation of radiation from the radiation generating apparatus 210 is stopped at time t9 after the delay time TD and the communication delay time TDc have elapsed from the time t8 when the radiation imaging apparatus 100 transmits the irradiation stop signal 226. As a result, the dose information is accumulated in the detection pixel 104 between the time t7 and the time t9. The calculating unit 171 can reduce the deterioration of the image quality of the radiation image due to the detection pixel 104 by using dose information for radiation image correction processing.

As described above, the radiation imaging system 200 according to the first embodiment includes the radiation generating apparatus 210 for generating the radiation, the controlling apparatus 230 for controlling the radiation generating apparatus 210, and the radiation imaging apparatus 100 for detecting the radiation and generating the radiation image. The radiation imaging apparatus 100 includes the sensor 221, the controlling unit 180, the threshold determining unit 222, and the calculating unit 171. The sensor 221 functions as an example of an imaging unit in which a plurality of pixels for detecting the radiation are arranged. The plurality of pixels may include the imaging pixel 101 for generating the signal used for generating the radiation image, and the detection pixel 104 for generating the signal indicating the irradiated dose of the radiation. The controlling unit 180 functions as an example of a controlling unit for controlling the plurality of pixels and stopping reading of the signal indicating the dose from the detection pixel 104 if the detected dose based on the signal indicating the dose of the radiation is at least one of the threshold Dth (first threshold) which varies with time and the threshold Dthcor (second threshold) different from the threshold Dth. The threshold determining unit 222 functions as an example of an output unit for outputting a stop signal for stopping the irradiation of radiation if the detected dose is equal to or greater than the first threshold, or if the detected dose is equal to or greater than the second threshold and the waiting time Twait elapse. The calculating unit 171 functions as an example of a generating unit for generating the radiation image using the signals accumulated in the imaging pixel 101 and the detection pixel 104.

Further, the sensor 221 functions as an example of a radiation detecting panel in which a plurality of pixels including a first kind of pixel and a second kind of pixel are arranged in a matrix. The controlling unit 180 and the threshold determining unit 222 function as an example of a unit for obtaining a cumulative dose information by performing dose detecting operation for reading charge of the second kind of pixel a plurality of times in a situation where the radiation is irradiated and the charge is accumulated in the first kind of pixel. The controlling unit 180 and the threshold determining unit 222 function as an example of a unit for performing processing of stopping the dose detecting operation and accumulating charge in the second kind of pixel based on a first threshold condition (threshold Dthcor) and the cumulative dose information. The threshold determining unit 222 functions as an example of a unit for performing processing of stopping the irradiation of radiation based on a second threshold condition (threshold Dth) and the cumulative dose information. The calculating unit 171 functions as an example of a unit for reading the charge of each of the first kind of pixel and the second kind of pixel and obtaining the radiation image.

With such a configuration, the radiation imaging apparatus 100 according to the first embodiment can stop the reading of dose by the detection pixel 104 according to the smaller of the threshold Dth and the threshold Dthcor. Further, the radiation imaging apparatus 100 can transmit the radiation stop signal for stopping the irradiation of radiation if the detected dose exceeds the threshold Dth or if the detected dose exceeds the threshold Dthcor and the waiting time lapses. Therefore, the radiation imaging apparatus 100 can perform the control of stopping the irradiation of radiation from the radiation generating apparatus 210 with high accuracy, and can reduce the deterioration of the image quality due to the detection pixel 104.

Here, the threshold Dth can be increased with time. Further, the relationship between the threshold Dth and the threshold Dthcor can be changed from the relationship in which the threshold Dth is equal to or less than the threshold Dthcor (equal to or less than the second threshold) to the relationship in which the threshold Dth is greater than the threshold Dthcor, with time. In this case, a smaller threshold can be used as the threshold for stopping the reading of dose by the detection pixel 104 according to the elapsed time, and more dose information can be accumulated in the detection pixel 104. Therefore, the degradation of the image quality due to the detection pixel 104 can be further reduced.

Further, the threshold value Dth may be determined based on the delay time from the output of the radiation stop signal until the irradiation of radiation is stopped. The delay time may include the communication delay time of the radiation stop signal and the delay time for the control of stopping the irradiation of the radiation. More specifically, the threshold value Dth may include the communication delay time when the radiation imaging apparatus 100 transmits the radiation stop signal to the controlling apparatus 230 and the delay time when the controlling apparatus 230 controls the radiation generating apparatus 210 to stop the irradiation of radiation. In this case, the radiation imaging apparatus 100 may transmit the radiation stop signal if the detected dose exceeds the threshold value Dth or a threshold value smaller than the threshold value Dth. Therefore, the radiation imaging apparatus 100 can perform the irradiation stop control of radiation with high accuracy in consideration of the delay time from the output of radiation stop signal until the irradiation of radiation stops.

The threshold value Dth may be increased with time based on the start time of the irradiation of radiation. The start time of the irradiation of radiation may be set to time when the detected dose becomes equal to or greater than the irradiation start threshold value (the third threshold value) different from the threshold value Dth and the threshold value Dthcor. In this case, radiation imaging apparatus 100 can specify the reference time when the threshold Dth increases with time as the start time of the irradiation of radiation based on the detected dose.

Further, the threshold determining unit 222 may calculate the waiting time Twait until the irradiated radiation dose exceeds the threshold Dth by using the detected dose and the elapsed time at the time when the reading of the signal indicating the dose from the detection pixel 104 is stopped. More specifically, the threshold determining unit 222 may calculate the waiting time Twait by further using the target value Dref which is the target dose and the delay time from the output of radiation stop signal until the irradiation of radiation is stopped.

The radiation imaging apparatus 100 may further include the threshold change controlling unit 224. The threshold change controlling unit 224 may function as an example of a changing unit for changing the threshold to be compared with the detected dose from the threshold Dth which varies with time to the threshold Dthcor based on the elapsed time from the start of the irradiation of radiation. More specifically, if the threshold Dth is greater than the threshold Dthcor in the elapsed time, the threshold change controlling unit 224 may change the threshold to be compared with the detected dose from the threshold Dth to the threshold Dthcor. According to such a configuration, the number of times of comparing the detected dose with the threshold can be reduced, the processing load can be reduced, and the processing speed can be increased.

The threshold value Dthcor may be a threshold value for accumulating a signal used for generating radiation image in the detection pixel. The threshold value Dthcor may be determined, for example, based on a predetermined rate of the target dose. The threshold value Dthcor may be determined based on an absolute amount of dose required to generate the radiation image. In this case, if the detected dose exceeds the threshold value Dthcor or a threshold value smaller than the threshold value Dthcor, the reading of the signal indicating dose by the detection pixel 104 is stopped, whereby the dose necessary for generating radiation image can be more certainly accumulated in the detection pixel 104. The threshold value Dthcor may be decreased with time based on the start time of the irradiation of radiation. In this case, the longer the irradiation time, the more dose information can remain in the detection pixel 104, and the deterioration of the S/N ratio of the radiation image can be suppressed.

Each of the plurality of pixels provided in the sensor 221 may include a detection element for detecting the radiation and a switch element for switching the output of the signal from the detection element. The conversion element 102, 105 may function as an example of the detection element, and the switch element 103, 106 may function as an example of the switch element. In this case, the controlling unit 180 may control the driving circuit to turn off the switch element 106 of the detection pixel 104, so that the reading of the signal indicating dose from detection pixel 104 can be stopped.

In the first embodiment, the threshold change controlling unit 224 changes the threshold value from the threshold value Dth to the threshold value Dthcor according to the elapsed time. On the other hand, the threshold determining unit 222 may determine whether the cumulative arrived-dose D exceeds the threshold value Dthcor if the cumulative arrived-dose D is smaller than the threshold value Dth without changing the threshold value by the threshold change controlling unit 224. Such processing will be described with reference to FIG. 3B. FIG. 3B is a flowchart showing another example of a series of the control method for the subject imaging according to the first embodiment. In FIG. 3B, the same processes as those in FIG. 3A are denoted by the same reference numerals and description thereof is omitted.

In the example shown in FIG. 3B, if the radiation is irradiated to the subject in step S303, the process proceeds to step S305′. In step S305′, first, the threshold determining unit 222 calculates a value representative of the dose of radiation detected by the sensor 221, and calculates a cumulative value of the value representative of the dose. This processing may be the same as the processing of calculating the cumulative value of the value representative of the dose in step S305.

The threshold determining unit 222 compares the calculated cumulative arrived-dose D with the threshold Dth set in step S302, and determines whether or not the cumulative arrived-dose D is smaller than the threshold Dth. As a result of this determination, if the cumulative arrived-dose D is smaller than the threshold Dth (step S305′/YES), the process proceeds to step S306′. On the other hand, as a result of the determination in step S305′, if the cumulative arrived-dose D is not smaller than the threshold Dth (the cumulative arrived-dose D is equal to or greater than the threshold Dth) (step S305′/NO), the process proceeds to step S307.

In step S306′, the threshold determining unit 222 compares the cumulative arrived-dose D calculated in step S305′ with the threshold Dthcor set in step S302, and determines whether or not the cumulative arrived-dose D is smaller than the threshold Dthcor. As a result of this determination, if the cumulative arrived-dose D is smaller than the threshold Dthcor (step S306′/YES), the process proceeds to step S305′. On the other hand, as a result of the determination in step S306′, if the cumulative arrived-dose D is not smaller than the threshold Dthcor (the cumulative arrived-dose D is equal to or greater than the threshold Dthcor) (step S306′/NO), the process proceeds to step S307′. If an affirmative determination (step S306′/YES) is made in step S306′, the threshold change controlling unit 224 performs the same processing as the processing of setting of the threshold Dth in step S302. Since the processes in and after step S307 and step S307′ is the same as the processes in FIG. 3A, a description thereof will be omitted.

With such a configuration, the threshold determining unit 222 may compares the detected dose with the threshold value without changing the threshold value by the threshold change controlling unit 224. Even with such a configuration, the radiation imaging apparatus 100 can perform the control of stopping the irradiation of radiation from the radiation generating apparatus 210 with high accuracy, and can reduce the degradation of the image quality due to the detection pixel 104.

### Second Embodiment

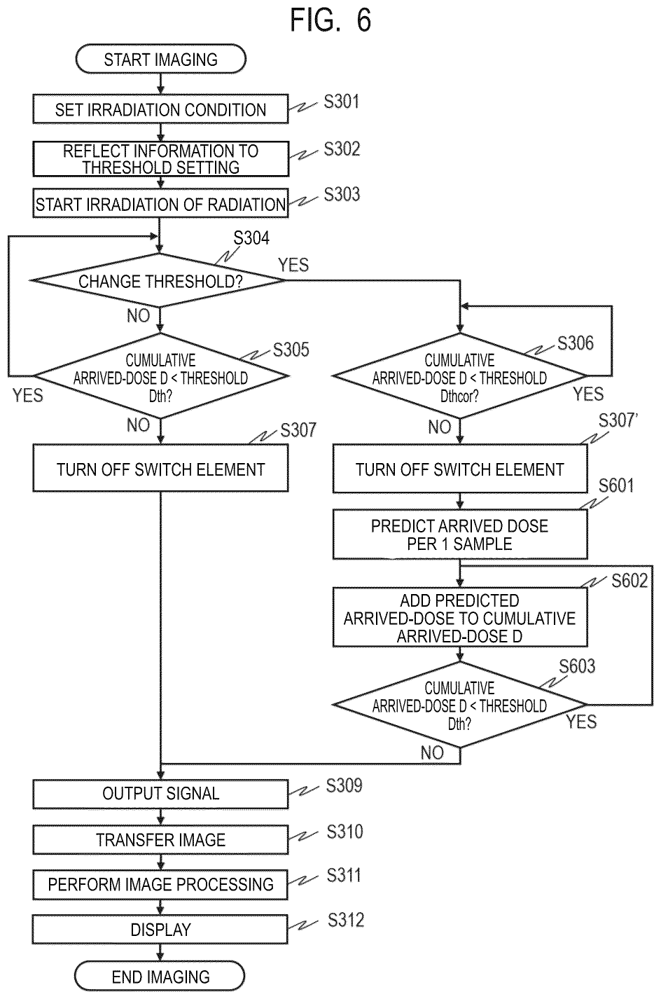

Next, a radiation imaging apparatus, a radiation imaging system, and a method of controlling a radiation imaging apparatus according to a second embodiment of the present disclosure will be described with reference to FIG. 4 and FIG. 6. Since the configurations of the radiation imaging apparatus and the radiation imaging system according to the second embodiment may be the same as those according to the first embodiment, the description thereof will be omitted using the same reference numerals. Hereinafter, the radiation imaging apparatus according to the second embodiment will be described focusing on differences from the radiation imaging apparatus according to the first embodiment. The radiation imaging apparatus 100 according to the second embodiment differs from the radiation imaging apparatus 100 according to the first embodiment in the prediction operation. Since other points of the second embodiment may be the same as those of the first embodiment, the description thereof will be omitted.

FIG. 6 is a flowchart showing an example of a series of control method for the subject imaging according to the second embodiment. In FIG. 6, the processing denoted by the same number means the same processing as that in FIG. 3A, and the description thereof will be omitted. In step S306 of FIG. 6, if the cumulative arrived-dose D is not smaller than the threshold Dthcor (the cumulative arrived-dose D is equal to or greater than the threshold Dthcor) (step S306/NO), the process proceeds to step S307′.

In step S307′, since the cumulative arrived-dose D exceeds (reaches) the threshold Dthcor, the output of the drive signal is stopped, the switch element of the pixel to be driven is turned off, and the accumulation operation of the dose information is started, as in the first embodiment. If the output of the drive signal is stopped, the process proceeds to step S601.

In step S601, since the detection pixel 104 is performing the accumulation operation, the read cumulative arrived-dose D does not increase. Therefore, the threshold determining unit 222 starts the prediction of the timing to output the irradiation stop notification. First, the threshold determining unit 222 calculates (predicts) arrived dose per one sample Dsmp. Here, the arrived dose per one sample Dsmp can be expressed as the following equation (3) using the sampling times Stotal, the cumulative arrived-dose D, and the elapsed time T from the threshold changing reference point O to the time when the cumulative arrived-dose reaches the threshold Dthcor in FIG. 4.

$$Dsmp = D ( T ) / Stotal \qquad Equation ( 3 )$$

The equation (3) represents gradient information of the dose of the irradiated radiation. Further, in the second embodiment, the arrived dose per one sample Dsmp (gradient information) is calculated as a first-order approximate expression, but the arrived dose per one sample Dsmp is not limited to this, and may be calculated as a second-order approximate expression or an exponential function. The arrived dose per one sample Dsmp may be calculated in advance from the irradiation condition obtained in step S301. If the calculation of the arrived dose per one sample Dsmp is completed, the process proceeds to step S602.

In step S602, if the time for one sample has elapsed, the cumulative arrived-dose D is predicted at time when the time for one sample has elapsed by using the arrived dose per one sample Dsmp calculated in step S601. Specifically, the threshold determining unit 222 adds the arrived dose per one sample Dsmp to the cumulative arrived-dose D up to the elapsed time T. As a result, the cumulative arrived-dose D when the time for one sample has elapsed can be calculated with respect to the cumulative arrived-dose D that does not increase because the switch element 106 of the detection pixel 104 is turned off in step S307′. The cumulative arrived-dose D (T+1) when the time for one sample has elapsed can be expressed by the following equation (4) using the cumulative arrived-dose D, the elapsed time T, and the arrived dose per one sample Dsmp.

$$D ( T + 1 ) = D ( T ) + Dsmp \qquad Equation ( 4 )$$

If the addition of the arrived dose per one sample Dsmp to the cumulative arrived-dose D is completed, the process proceeds to step S603. Further, if the time variation of the threshold Dth of the cumulative arrived-dose is set, the threshold change controlling unit 224 performs the same processing as the processing of setting of the threshold Dth in step S302 in step S602.

In step S603, first, the threshold determining unit 222 compares the cumulative arrived-dose D calculated in step S602 with the threshold Dth, and determines whether or not the cumulative arrived-dose D is smaller than the threshold Dth. As a result of this determination, if the cumulative arrived-dose D is smaller than the threshold Dth (step S603/YES), the process proceeds to step S602. On the other hand, as a result of the determination in step S603, if the cumulative arrived-dose D is not smaller than the threshold Dth (the cumulative arrived-dose D is equal to or greater than the threshold Dth) (step S603/NO), the process proceeds to step S309. Since the processes in and after step S309 are the same as those in the first embodiment, the description thereof will be omitted.

In the second embodiment, the processes of step S602 and step S603 are repeated every time the time for one sample has elapsed until the cumulative arrived-dose D of the radiation calculated in step S602 exceeds the threshold Dth. It is also assumed that the waiting time Twait has elapsed when the cumulative arrived-dose D of the radiation calculated in step S602 exceeds the threshold Dth. Therefore, also in the second embodiment, even after the cumulative arrived-dose D exceeds the threshold Dthcor, the accumulation operation of detection pixel 104 is continued until the predicted cumulative arrived-dose D exceeds the threshold Dth, whereby the dose information used for radiation image correction can be obtained. Further, since the threshold Dth is a threshold in consideration of dose corresponding to the communication delay time TDc and the delay time TD, the irradiation stop control of radiation can be controlled with high accuracy.

As described above, the threshold determining unit 222 according to the second embodiment may determine whether or not the waiting time has elapsed by further using the detected dose, the elapsed time at the time when the reading of the signal indicating the dose from the detection pixel 104 is stopped, and threshold Dth. More specifically, the threshold determining unit 222 may determine dose per one sampling time for the detection of the dose by using the detected dose and the elapsed time at the time when the reading of the signal indicating the dose from the detection pixel 104 is stopped. The threshold determining unit 222 may add the dose per one sampling time to the detected dose for each one sampling time. Further, the threshold determining unit 222 may determine that the waiting time has elapsed if the cumulative value of dose to which the dose per one sampling time is added becomes equal to or greater than the threshold Dth. Even with this configuration, the radiation stop signal can be output based on the threshold Dth, and the irradiation stop control of the radiation can be controlled with high accuracy.

In the second embodiment, similarly to the modification of the first embodiment, the threshold determining unit 222 may compare the detected dose with the threshold without changing the threshold by the threshold change controlling unit 224. In this case, instead of the processing of step S308 in FIG. 3B, the processing of steps S601 to S603 may be performed. Even with this configuration, the radiation imaging apparatus 100 can perform the irradiation stop control of the radiation from the radiation generating apparatus 210 with high accuracy, and can reduce the deterioration of the image quality due to the detection pixel 104.

According to the first or second embodiment of the present disclosure, the irradiation stop control of the radiation from the radiation generating apparatus can be performed with high accuracy, and the deterioration of the image quality due to the detection pixel can be reduced.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The processor or circuit may include a central processing unit (CPU), a microprocessing unit (MPU), a graphics processing unit (GPU), an application specific integrated circuit (ASIC), or a field programmable gateway (FPGA). The processor or circuit may also include a digital signal processor (DSP), a data flow processor (DFP), or a neural processing unit (NPU).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-162861, filed Sep. 26, 2023, which is hereby incorporated by reference herein in its entirety.

What is claimed is:

1. A radiation imaging apparatus comprising:
a radiation detecting panel in which a plurality of pixels including a first kind of pixel and a second kind of pixel are arranged in a matrix;
a unit configured to obtain a cumulative dose information by performing dose detecting operation for reading charge of the second kind of pixel a plurality of times in a situation where radiation is irradiated and charge is accumulated in the first kind of pixel;
a unit configured to perform processing of stopping the dose detecting operation and stopping the irradiation of radiation based on a combination of a first threshold condition and the cumulative dose information or a combination of a second threshold condition and the cumulative dose information; and
a unit configured to read the charge of each of the first kind of pixel and the second kind of pixel and obtain a radiation image.

2. The radiation imaging apparatus according to claim 1, wherein:
the second threshold condition increases with time; and
relationship between the first threshold condition and the second threshold condition becomes from relationship in which the second threshold condition is equal to or smaller than the first threshold condition to relationship in which the second threshold condition is greater than the first threshold condition, with time.

3. The radiation imaging apparatus according to claim 2, wherein the second threshold condition is determined based on delay time from output of a stop signal for stopping the irradiation of radiation up to a stop of the irradiation of radiation.

4. The radiation imaging apparatus according to claim 3, wherein the delay time includes communication delay time of the stop signal and delay time for control of stopping the irradiation of radiation.

5. The radiation imaging apparatus according to claim 2, wherein the second threshold condition increases with time based on start time of the irradiation of radiation.

6. The radiation imaging apparatus according to claim 5, wherein the start time of the irradiation of radiation is time at which the cumulative dose information is equal to or greater than a third threshold condition different from the first and second threshold conditions.

7. The radiation imaging apparatus according to claim 1, wherein the unit configured to perform the processing of stopping the irradiation of radiation:
calculates waiting time until irradiated dose of the radiation exceeds the second threshold condition by using elapsed time at time when the dose detecting operation is stopped and the cumulative dose information; and
performs the processing of stopping the irradiation of radiation if the waiting time has elapsed from the elapsed time.

8. The radiation imaging apparatus of claim 7, wherein the unit configured to perform the processing of stopping the irradiation of radiation:
calculates the waiting time by further using target dose and delay time from output of a stop signal for stopping the irradiation of radiation up to a stop of the irradiation of radiation; and
performs the processing of stopping the irradiation of radiation if the waiting time has elapsed from the elapsed time.

9. The radiation imaging apparatus according to claim 1, wherein the unit configured to perform the processing of stopping the irradiation of radiation determines whether waiting time until the processing of stopping the irradiation of radiation is performed has elapsed by using the cumulative dose information, elapsed time at time when the dose detecting operation is stopped, and the second threshold condition.

10. The radiation imaging apparatus according to claim 9, wherein the unit configured to perform the processing of stopping the irradiation of radiation:
determines dose per one sampling time of the dose detection operation by using the cumulative dose information and the elapsed time;
adds the dose per one sampling time to the cumulative dose information for each sampling time;
determines that the waiting time has elapsed if the cumulative value of dose to which the dose per one sampling time is added is equal to or greater than the second threshold condition.

11. The radiation imaging apparatus according to claim 1, further comprising a unit configured to change a threshold used for the processing of stopping the irradiation of radiation from the second threshold condition to the first threshold condition based on elapsed time from start of the irradiation of radiation.

12. The radiation imaging apparatus according to claim 11, wherein:
the second threshold condition increases with time;
relationship between the first threshold condition and the second threshold condition becomes from relationship in which the second threshold condition is equal to or smaller than the first threshold condition to relationship in which the second threshold condition is greater than the first threshold condition, with time; and
the unit configured to change the threshold used for the processing of stopping the irradiation of radiation changes the threshold used for the processing of stopping the irradiation of radiation from the second threshold condition to the first threshold condition if the second threshold condition is greater than the first threshold condition at the elapsed time.

13. The radiation imaging apparatus according to claim 1, wherein the first threshold condition is a threshold for accumulating charge used to generate the radiation image in the second kind of pixel.

14. The radiation imaging apparatus according to claim 1, wherein the first threshold condition is determined based on a predetermined rate of target dose.

15. The radiation imaging apparatus according to claim 1, wherein the first threshold condition is determined based on an absolute amount of dose required to generate the radiation image.

16. The radiation imaging apparatus according to claim 1, wherein the first threshold condition decreases with time based on start time of the irradiation of radiation.

17. The radiation imaging apparatus according to claim 1, wherein:
each of the plurality of pixels includes a detection element arranged to detect the radiation and a switch element arranged to switch output of a signal from the detection element,
the unit configured to stop the dose detecting operation stops the reading of the charge from the second kind of pixel by turning off the switch element of the second kind of pixel.

18. A radiation imaging system comprising:
a controlling apparatus configured to control a radiation generating apparatus arranged to generate radiation; and
the radiation imaging apparatus according to claim 1.

19. A method of controlling a radiation imaging apparatus comprising a radiation detecting panel in which a plurality of pixels including a first kind of pixel and a second kind of pixel are arranged in a matrix, the method comprising;
obtaining a cumulative dose information by performing a dose detecting operation for reading charge of the second kind of pixel a plurality of times in a situation where radiation is irradiated and charge is accumulated in the first kind of pixel;
performing processing of stopping the dose detecting operation and stopping the irradiation of radiation based on a combination of a first threshold condition and the cumulative dose information or a combination of a second threshold condition and the cumulative dose information; and
reading the charge of each of the first kind of pixel and the second kind of pixel and obtain a radiation image.

20. A radiation imaging apparatus comprising:
a radiation detecting panel in which a plurality of pixels including a first kind of pixel and a second kind of pixel are arranged in a matrix;
a unit configured to obtain a cumulative dose information by performing dose detecting operation for reading charge of the second kind of pixel a plurality of times in a situation where radiation is irradiated and charge is accumulated in the first kind of pixel;
a unit configured to perform processing of stopping the dose detecting operation and accumulating charge in the second kind of pixel based on a first threshold condition and the cumulative dose information;
a unit configured to perform processing of stopping the irradiation of radiation based on a second threshold condition and the cumulative dose information; and
a unit configured to read the charge of each of the first kind of pixel and the second kind of pixel and obtain a radiation image.
